(19) United States
(12) Patent Application Publication
(10) Pub. No.: US 2015/0062858 A1
(43) Pub. Date: Mar. 5, 2015

(54) CABLE ALIGNMENT DEVICES AND ASSOCIATED SYSTEMS AND METHODS

(71) Applicant: QSC Audio Products, LLC, Costa Mesa, CA (US)

(72) Inventors: Jonathan Kemp, Dana Point, CA (US); Paul C. Nelson, Yorba Linda, CA (US); Paul Christian McDonald, Huntington Beach, CA (US)

(73) Assignee: QSC Audio Products, LLC, Costa Mesa, CA (US)

(21) Appl. No.: 14/077,161

(22) Filed: Nov. 11, 2013

Related U.S. Application Data
(60) Provisional application No. 61/873,283, filed on Sep. 3, 2013.

(51) Int. Cl. H01B 7/00; H01B 7/40

(52) U.S. Cl. CPC H01B 7/0045; H01B 7/40
USPC 361/826; 174/72 A

(57) ABSTRACT

The present technology relates generally to cable alignment devices and associated systems and methods. Particular embodiments are directed to cable alignment systems for aligning and registering a plurality of cables with an electronic device, such as an electronic mixer. In some embodiments, a cable alignment system includes an electronic device having a plurality of receiving apertures therein. The system can include a plurality of cables configured to electronically communicate with the electronic device. The system can further include a cable alignment device that is configured to receive the plurality of cables. A plurality of projections can extend from the cable alignment device, and individual projections can be sized to fit within the individual receiving apertures. The cable alignment device can retain the cables in a fixed and spaced arrangement to attach all of the cables to the electronic device simultaneously.

### CROSS REFERENCE TO RELATED APPLICATION

This application claims the benefit of and priority to U.S. Provisional Patent Application No. 61/873,283, titled Cable Alignment Devices and Associated Systems and Methods and filed Sep. 3, 2013, which is incorporated herein in its entirety by reference thereto.

### TECHNICAL FIELD

The present technology relates generally to cable alignment devices and associated systems and methods. Particular embodiments are directed to cable alignment devices for aligning and registering a plurality of cables with an electronic device.

### BACKGROUND

Several types of electronic devices use of multiple cable connectors. For example, sound engineers often use a mixing console, or audio mixer, to combine, route, and change the level, timbre and/or dynamics of audio signals. The audio input signals typically are produced at different respective levels. Exemplary audio input signals may be derived or received from a microphone, an audio tape recorder, a video tape recorder or similar electronic device. Typically, a plurality of electronic devices for signal input or output are connected to common mixing console or other common electronic device via a tangle of cables. Such use of multiple cables can create difficulty in keeping the cables organized, routing the cables to correct connection port on the common electronic device, and inefficient set up or adjustment when trying to form the connections between the multiple electronic devices.

### BRIEF DESCRIPTION OF THE DRAWINGS

FIG. 1A is an isometric illustration of a cable alignment device interfaced with an electronic device and configured in accordance with embodiments of the technology.

FIG. 1B is an isometric illustration of the cable alignment device of FIG. 1A detached from the electronic device and configured in accordance with embodiments of the technology.

FIG. 2A is a top view illustration of the cable alignment device of FIG. 1B.

FIG. 2B is a cross-sectional side view illustration of the cable alignment device of FIG. 2A having a cable connector positioned therein and configured in accordance with embodiments of the technology.

FIG. 3A is a top view illustration of a cable alignment device configured in accordance with embodiments of the technology.

FIG. 3B is a cross-sectional side view illustration of the cable alignment device of FIG. 3A having a cable connector positioned therein and configured in accordance with embodiments of the technology.

### DETAILED DESCRIPTION

The present technology relates generally to cable alignment devices and associated systems and methods. Particular embodiments are directed to cable alignment systems for aligning and registering a plurality of cables with an electronic device, such as an electronic mixer. In some embodiments, a cable alignment system includes an electronic device having a plurality of receiving apertures therein. The system can include a plurality of cables configured to electronically communicate with the electronic device. The system can further include a cable alignment device configured to receive the plurality of cables. A plurality of projections can extend from the cable alignment device, and individual projections can be sized to fit within the individual receiving apertures. The cable alignment device can retain the cables in a fixed and spaced arrangement to position and/or attach all of the cables to the electronic device substantially simultaneously.

In some embodiments, the cables can be movable between a first configuration in which the cables are in electronic communication with the electronic device and a second configuration in which the cables are out of electronic communication with the electronic device. The cables can be collectively moved from the first configuration to the second configuration by a single movement of the cable alignment device.

In several embodiments, the receiving apertures can be in a receiving aperture pattern and the projections can be arranged in a projection pattern matching the receiving aperture pattern. In particular embodiments, the plurality of projections are generally linearly aligned in the projection pattern. In various embodiments, the individual projections are integral to individual cables or to the cable alignment device. In some embodiments, the individual projections include projection apertures therethrough, and individual cables have a plurality of electronic connection pins extending therefrom and are sized to fit in and extend through the projection apertures. In particular embodiments, individual projections are generally cylindrically-shaped.

In some embodiments, the cable alignment device includes individual shoulder portions proximate to individual cable apertures, and the shoulder portions are sized to retain the cables in a position relative to the cable alignment device. The shoulder portions can align the cables with the corresponding receiving apertures.

In another embodiment, a cable alignment device for aligning and registering a plurality of cables with an electronic device includes a connection plate having a first surface and a second surface opposite the first surface. The device can further include a plurality of projections extending from the second surface of the connection plate. The projections can include a plurality of apertures therethrough, where the apertures are sized to receive a portion of the cables and retain the cables in a fixed and spaced arrangement. In some embodiments, the apertures are spaced apart in a generally linear arrangement.

In still further embodiments, a cable alignment system includes an electronic device and a cable alignment device configured to retain a plurality of cables in a fixed and spaced arrangement. In some embodiments, the cable alignment device is movable between a first configuration in which the plurality of cables are out of electronic communication with the electronic device and a second configuration in which the plurality cables are collectively electronically registered with the electronic device.

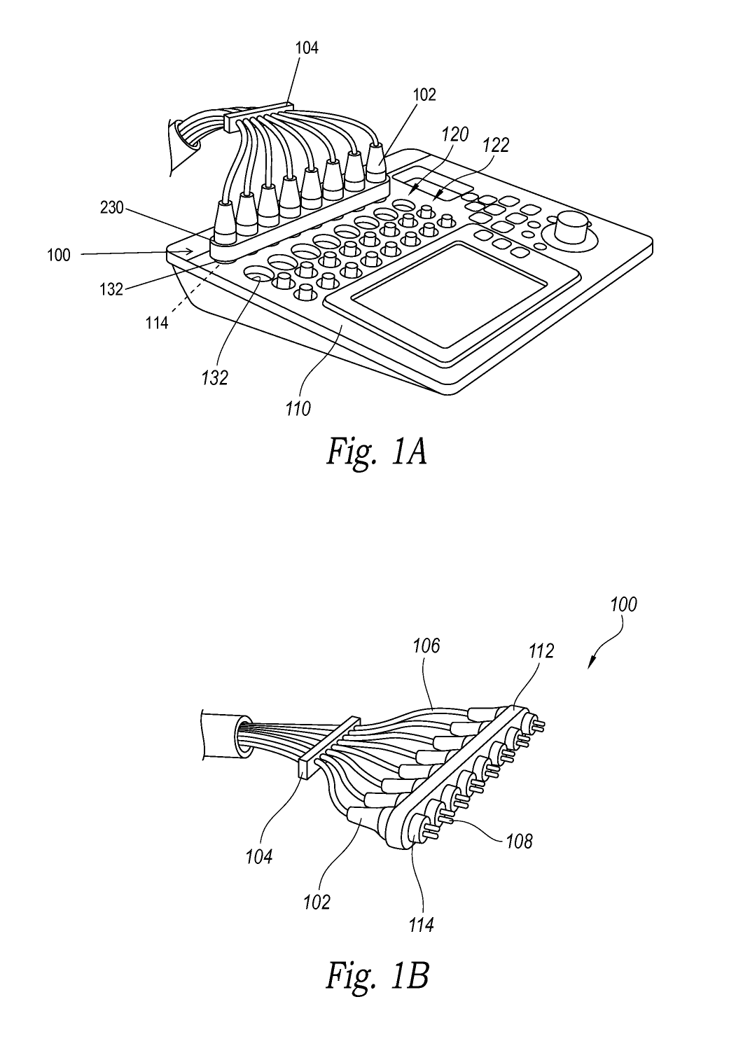

Specific details of several embodiments of the technology are described below with reference to FIGS. 1A-3B. Other details describing well-known structures and systems often associated with cable alignment devices and electronic devices have not been set forth in the following disclosure to avoid unnecessarily obscuring the description of the various embodiments of the technology. Many of the details, dimensions, angles, and other features shown in the Figures are merely illustrative of particular embodiments of the technology. Accordingly, other embodiments can have other details, dimensions, angles, and features without departing from the spirit or scope of the present technology. A person of ordinary skill in the art, therefore, will accordingly understand that the technology may have other embodiments with additional elements, or the technology may have other embodiments without several of the features shown and described below with reference to FIGS. 1A-3B.

FIG. 1A is an isometric illustration of a cable alignment device 100 interfaced with an electronic device 110 and configured in accordance with embodiments of the technology. FIG. 1B is an isometric illustration of the cable alignment device 100 of FIG. 1A detached from the electronic device 110. Referring to FIGS. 1A and 1B together, the electronic device 110 can be any type of electronic device having one or more input and/or outlet connections, and in particular embodiments the electronic device 110 can be a mixing console. The electronic device 110 can include a receiving component 120 with a plurality of connector receiving apertures 132 suitable for interfacing with individual input/output connectors (collectively referred to as “cable connectors 102”). The electronic device 110 can further include one or more controls 122 to perform various operations, such as adjusting an input signal provided by input connections.

The cable alignment device 100 of the illustrated embodiment removeably receives, aligns, and holds a plurality of the cable connectors 102 in a selected arrangement that matches the arrangement of the connector receiving apertures 132 in the electronic device 110. As discussed in greater detail below, the cable alignment device 100 of at least one embodiment has a connector plate portion 112 with a plurality of spaced apart receiving apertures 230 that removeably receive and retain the cable connectors 102 in a selected arrangement and orientation relative to each other and the connector plate portion. The alignment device 100 also has a plurality of spaced apart projections 114 coaxially aligned with the receiving apertures 230 and configured so that portions of the cable connectors 102 extend through and/or are accessible through the projections. The projections 114 are sized to plug into the receiving apertures 132 in the electronic device 110 so that the cable connectors 102 operatively engage mating connectors in the connector receiving apertures 132.

In the illustrated embodiment, the plurality of cables 106 connected to the cable connectors 102 are bundled via a cable bundler 104 and a sheath or conduit. In further embodiments, the cables 106 are not bundled. In still further embodiments, the cable connectors 102 do not include a cable 106, and can be wireless. The cable 106 in the illustrated embodiment is a multi-strand cable containing electrical wires, although the cable in other embodiments can be a single strand cable, a fiber optic cable, a multi-strand or single strand communication line, a conduit, or the like.

The individual cable connectors 102 can include a communicative interface, such as pins 108, to register with the electronic device 110. More specifically, the pins 108 can mate with a corresponding interface (e.g., a male/female counterpart or electronic receptacle) at the receiving component 120 on the electronic device 110. While each cable connector 102 is shown having two pins 108 extending from the projections 114, the cable connectors 102 in other embodiments can have more or fewer pins or other types of communicative interface extending from or otherwise accessible through the projections 114. The cable connectors 102 are releasably coupled to the connection plate 112 such that individual cable connectors 102 can be interchanged or removed from the connection plate 112 depending on the particular requirement of the electronic device 110 and the user. In further embodiments, each cable connector 102 can be retained in the receiving apertures 230 in the connection plate via a friction fit engagement, by a mechanical retention device (e.g., screws, clips, snaps, etc), or by a permanent attachment means.

In the illustrated embodiment, the projections 114 on the cable alignment device 100 are sized and shaped to plug into or otherwise interface with the receiving apertures 132 in the receiving component 120. The individual projections 114 can be integral to the connection plate 112. In still further embodiments, the projections 114 can be removably coupled to the connection plate 112.

In several embodiments, the plurality of projections 114 are provided in a pattern or arrangement that corresponds to or matches a pattern or arrangement of some or all of the receiving apertures 132 in the electronic device 110. For example, the receiving apertures 132 and projections 114 can each be linearly aligned (e.g., a linear row of circular apertures 132 and projections 114). In another embodiment, the apertures 132 and projections 114 are linearly offset, arranged in a circular or rectangular pattern, or positioned in another arrangement, such as one that efficiently utilizes space on the electronic device 110.

In some embodiments, the receiving apertures 132 and projections 114 can have the same cross-sectional shape. For example, in the illustrated embodiment, individual projections 114 are generally cylindrical with a circular cross-section. The receiving apertures 132 are likewise generally cylindrical recesses having a circular cross-section. In some embodiments, the receiving apertures 132 can include a communicative interface, such as conductive receiving pads or surfaces, to interface with pins 108 extending from and/or through the projections 114. Although the illustrated embodiment shows a male/female interface wherein the cable connectors 102 have the pins 108 extending from the projections 114, other embodiments can have a reversed male/female interface wherein the cable connectors have a female connector portion accessible through the projections 114. Also, while the projections 114 and receiving apertures 132 are shown as having a circular cross-section, they can have other shapes (e.g., square, rectangular, triangular, polygonal, connected circles, etc.) or a combination of shapes in other embodiments, and need not necessarily all have the same shape.

In the illustrated embodiment, the alignment device 100 holds the plurality of cable connectors 102 in fixed relationship relative to each other, such that the alignment device 100 and cable connectors 102 can be collectively moved between a first configuration in which the cable connectors 102 are in electronic communication with the electronic device 110, and a second configuration in which the cable connectors 102 are out of electronic communication with the electronic device 110. The connection plate 112 holds the cable connectors 102 in a fixed and spaced arrangement that matches the receiving apertures, so all of the cable connectors attached to the connection plate 112 can be substantially simultaneously positioned adjacent to and/or plugged into (or removed from) their respective receiving aperture 132 in the electronic device 110.

In some embodiments, the connection plate 112 or other portion of the cable alignment device 100 can include one or more grip features, such as a roughened or high-friction material or surface to improve gripping for easier attachment or detachment between the cable alignment device 100 and the electronic device 110. In various embodiments, the cable alignment device 100 can be at least partially made of plastic, silicone, rubber, or other suitable material or combination of materials. In other embodiments, edge portions of the connection plate 112 or other portions of the cable alignment device 100 can have one more securing mechanisms that releasably attach to the electronic device 110 to hold the connection plate 112 in a fixed position relative to the receiving apertures 132 so that the cable connectors 102 cannot inadvertently disconnect or disengage from the receiving apertures 132 and associated connection members therein. In yet another embodiment, the edge portions of the connection pate 112 or other portions of the cable alignment device 100 can have one more receiving portions for releasably receiving a locking mechanisms on the electronic device 110 that reliably locks the cable alignment device 100 and associated cable connectors 102 in position relative to the electronic device.

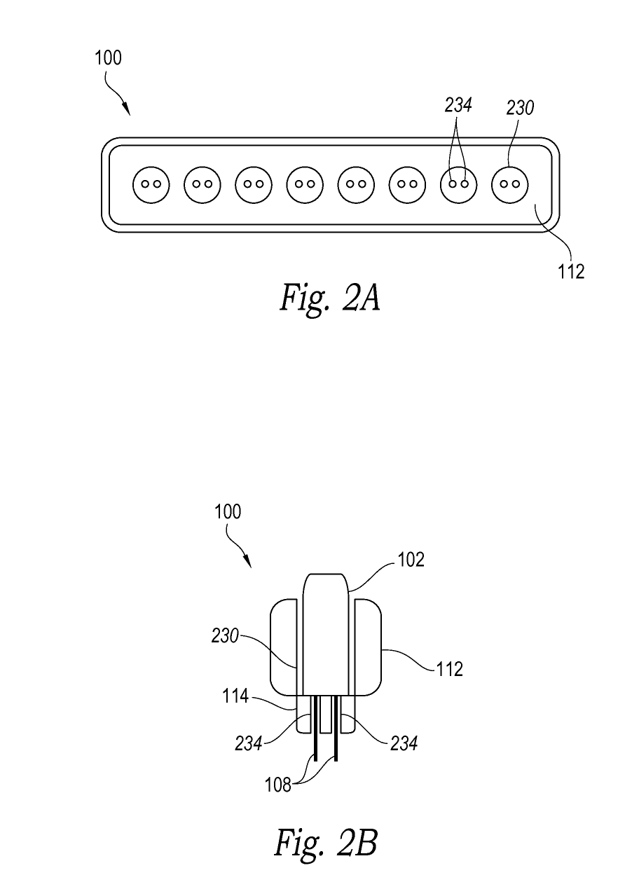

FIG. 2A is a top view illustration of a cable alignment device 200 configured in accordance with embodiments of the technology. FIG. 2B is a cross-sectional side view illustration of the cable alignment device 100 of FIG. 2A having a cable connector 102 positioned therein. Referring to FIGS. 2A and 2B together, the projections 114 of the connection plate 112 include the receiving apertures 230, each of which terminates at or adjacent to the projection 114, and that communicates with pin apertures 234 that extend through the projection 114 and that receive the pins 108 therethrough. Accordingly, a shielded portion of each pin 108 is within its respective pin aperture 234, and a connection portion of the pin 108 extends from the pin aperture 234 and the corresponding projection 114. The exposed connection portion of the pin 108 can electronically connect to a corresponding communicative interface in the electronic device as described above.

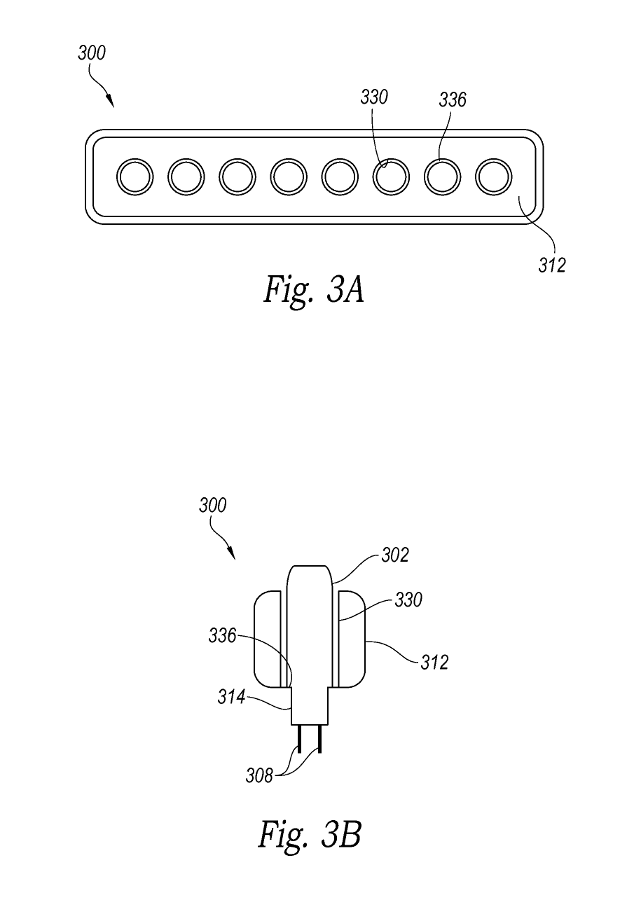

FIG. 3A is a top view illustration of a cable alignment device 300 configured in accordance with embodiments of the technology. FIG. 3B is a cross-sectional side view illustration of the cable alignment device 300 of FIG. 3A having a cable connector 302 positioned therein. Referring to FIGS. 3A and 3B together, the cable alignment device 300 has several features generally similar to those described above with reference to FIGS. 1A-2B. For example, the cable alignment device 300 can include projections 314 sized and shaped for interfacing with a receiving component in an electronic device. In the illustrated embodiment, the projections 314 are integral to the cable connectors 302. In several embodiments, the individual cable connectors 302 can include a communicative interface, such as one or more pins 308, extending therefrom. The pins 308 can register with an electronic device as described above.

The cable alignment device 300 includes a connection plate 312 having a plurality of receiving apertures 330 for removably holding the cable connectors 302. As described above, the connection plate 312 can retain the cable connectors 302 in a fixed and spaced arrangement to attach or detach all of the cable connectors 302 to a receiving component of an electronic device. In some embodiments, for example, the connection plate 312 can include a shoulder 336 within, around, or otherwise proximate to individual receiving apertures 330. The shoulder 336 can prevent the cable connectors 302 from sliding through the apertures 330 (e.g., the shoulder 336 can “catch” or retain the cable connector in the aperture 330 or can otherwise ensure temporary attachment between the cable connectors 302 and the connection plate 312). In some embodiments, the shoulder 336 and cable connector 302 can include complementary engagement features (e.g., a groove, slot, projection, clasp, etc.) to align the cable connectors 302 in the apertures 330 so the cable connectors 302 can effectively interface with corresponding receiving apertures in the electronic device.

The technology disclosed herein offers several advantages over traditional cable alignment systems. For example, the cable alignment devices described above provide for easy, one-step attachment and detachment between an electronic device and multiple cables. This reduces the time it takes to set up the electronic device for use and organizes the multiple cables. Further, the alignment devices can prevent tangling among the multiple cables by keeping them in a fixed and spaced-apart arrangement.

From the foregoing it will be appreciated that, although specific embodiments of the technology have been described herein for purposes of illustration, various modifications may be made without deviating from the spirit and scope of the technology. Further, certain aspects of the new technology described in the context of particular embodiments may be combined or eliminated in other embodiments. Moreover, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein. Thus, the disclosure is not limited except as by the appended claims.

I/we claim:

1. A cable alignment system, comprising:
an electronic device having a plurality of receiving apertures therein;
a plurality of cables configured to electronically communicate with the electronic device;
a cable alignment device configured to retain the plurality of cables in a fixed relationship; and
a plurality of projections extending from the cable alignment device, wherein individual projections are sized to fit within the individual receiving apertures.

2. The system of claim 1 wherein the plurality of cables are movable between a first configuration in which the plurality of cables are in electronic communication with the electronic device and a second configuration in which the plurality of cables are out of electronic communication with the electronic device, and wherein the plurality of cables are collectively movable from the first configuration to the second configuration by a single movement of the cable alignment device.

3. The system of claim 1 wherein the receiving apertures are in a receiving aperture pattern and the projections are arranged in a projection pattern matching the receiving aperture pattern.

4. The system of claim 3 wherein the plurality of projections are generally linearly aligned in the projection pattern.

5. The system of claim 1 wherein individual projections are integral to individual cables.

6. The system of claim 1 wherein the plurality of projections are integral to the cable alignment device.

7. The system of claim 1 wherein individual projections include at least one projection aperture therethrough, and wherein individual cables have at least one electronic interface extending therefrom, the electronic interface being sized to fit in and extend through the projection aperture.

8. The system of claim 7 wherein the electronic interface comprises a conductive pin.

9. The system of claim 1 wherein individual projections are generally cylindrically-shaped.

10. The system of claim 1 wherein the cable alignment device includes a plurality of cable apertures, with each cable aperture having a shoulder portion therein, the shoulder portion being sized to retain an individual cable in a position relative to the cable alignment device.

11. The system of claim 1 wherein the electronic device comprises an electronic mixer.

12. A cable alignment device for aligning and registering a plurality of cables with an electronic device, the cable alignment device comprising:
a connection plate having a first surface and a second surface opposite the first surface; and
a plurality of projections extending from the second surface of the connection plate, wherein:
the projections include a plurality of apertures therethrough; and
the apertures are sized to receive a portion of individual cables and retain the plurality of cables in a fixed and spaced arrangement.

13. The device of claim 12 wherein the projections are spaced apart in a generally linear arrangement.

14. The system of claim 12 wherein individual projections are generally cylindrically-shaped.

15. The device of claim 12 wherein the electronic device comprises an electronic mixer.

16. A cable alignment system, comprising:
an electronic device; and
a cable alignment device configured to retain a plurality of cables in a fixed and spaced arrangement, wherein the cable alignment device is movable between a first configuration in which the plurality of cables are out of electronic communication with the electronic device and a second configuration in which the plurality cables are collectively electronically registered with the electronic device.

17. The system of claim 16 wherein the cable alignment device includes a plurality of projections extending therefrom, the individual projections being configured to retain individual cables, and wherein the electronic device includes a plurality of receiving apertures sized and arranged to receive the plurality of projections when the cable alignment device is in the second configuration.

18. The system of claim 17 wherein the receiving apertures are in a receiving aperture pattern and the projections are arranged in a fixed projection pattern matching the receiving aperture pattern.

19. The system of claim 17 wherein individual projections include at least one projection aperture therein, the projection aperture sized to receive a portion of an individual cable therethrough.

20. The system of claim 16 wherein the electronic device comprises an electronic mixer.
